(19) United States
(12) Patent Application Publication
(10) Pub. No.: US 2020/0050077 A1
(43) Pub. Date: Feb. 13, 2020

(54) OPTICAL SHUTTER FOR CAMERA MODULE AND PRODUCTION METHOD THEREOF

(71) Applicant: SHARP KABUSHIKI KAISHA, Sakai City (JP)

(72) Inventors: MASANOBU MIZUSAKI, Sakai City (JP); KIYOSHI MINOURA, Sakai City (JP)

(21) Appl. No.: 16/515,841

(22) Filed: Jul. 18, 2019

Related U.S. Application Data
(60) Provisional application No. 62/718,020, filed on Aug. 13, 2018.

(51) Int. Cl. G03B 9/08; G02F 1/1333; G02F 1/1343

(52) U.S. Cl. CPC G03B 9/08; G02F 1/13439; G02F 1/133365

(57) ABSTRACT

The present invention provides a highly reliable optical shutter for camera modules capable of preventing the occurrence of a streaky transparent portion in a polymer network liquid crystal layer in a scattering state, and a method for producing the optical shutter for camera modules. The optical shutter for camera modules includes: a pair of substrates bonded together with a seal; and a polymer network liquid crystal layer sealed between the substrates, wherein at least one of the substrates includes a transparent electrode made of an oxide conductive film and a coating film that covers the transparent electrode and contains a polymer with a polyamic acid structure in a main chain.

### CROSS-REFERENCE TO RELATED APPLICATIONS

The present application claims priority under 35 U.S.C. § 119 to U.S. Provisional Patent Application No. 62/718,020 filed on Aug. 13, 2018, the contents of which are incorporated herein by reference in their entirety.

### BACKGROUND OF THE INVENTION

### Field of the Invention

The present invention relates to optical shutters for a camera module and production methods thereof. More specifically, the present invention relates to an optical shutter for camera modules which employs a polymer network liquid crystal layer and a production method thereof.

### Description of Related Art

Conventional cameras generally include a mechanical optical shutter in which one or more partition plates open and close at a high speed by the force of a spring. Due to various purposes such as reduction in size and thickness, impact resistance, production cost, and increase in speed, electrical optical shutters have been increasingly developed. Examples of electrical optical shutters include a shutter disclosed in JP 2007-208587 A which includes a dispersion-type liquid crystal element.

### BRIEF SUMMARY OF THE INVENTION

A polymer network liquid crystal (PNLC) layer has properties of scattering light when no voltage is applied and transmitting light when voltage is applied. The present inventors focused on production of an optical shutter for camera modules that uses such properties of a PNLC layer. The present inventors experimentally produced a PNLC cell for such an optical shutter including a PNLC layer between paired substrates bonded together with a seal, and found that a streaky transparent portion (hereinafter also referred to as “cracked-patterned defect”) was generated in the PNLC layer in a scattering state. FIG. 4 illustrates a schematic plan view of a cracked-patterned defect that occurred in a conventional optical shutter for camera modules. According to studies of the present inventors, a cracked-patterned defect 90 occurred near a seal 40 that seals a PNLC layer 30 and the defect tended to develop over the entire surface of the PNLC layer 30 as time passed. It was also found that the cracked-patterned defect 90 became noticeable when subjected to an aging test such as a high-temperature test.

JP 2007-208587 A does not disclose occurrence of such a cracked-patterned defect in a device including a PNLC layer.

The present invention was made in view of the current situation, and aims to provide a highly reliable optical shutter for camera modules capable of preventing the occurrence of a streaky transparent portion in a polymer network liquid crystal layer in a scattering state, and a method for producing the optical shutter for camera modules.

As a result of various studies on cracked-patterned defects, the present inventors predicted that the cause of the defects would be separation of a polymer network constituting the PNLC layer from the surface of a transparent electrode that is used to apply voltage to the PNLC layer. With reference to FIGS. 5A and 5B, the following will describe the mechanism of occurrence of a cracked-patterned defect based on the prediction of the present inventors. FIG. 5A is a schematic cross-sectional view of a conventional optical shutter for camera modules in a normal state. FIG. 5B is a schematic cross-sectional view of a conventional optical shutter for camera modules in a state with a cracked-patterned defect.

As illustrated in FIG. 5A, in a PNLC cell in a normal state, a polymer network 31 is in contact with a transparent electrode 12 disposed on a transparent substrate 11 and a transparent electrode 22 disposed on a transparent substrate 21, and liquid crystal droplets 32 in the PNLC layer 30 are separated from transparent electrodes 12 and 22. The transparent electrodes 12 and 22 are usually oxide conductive films such as indium tin oxide (ITO) electrodes. However, while oxide conductive films such as ITO electrodes are slightly hydrophilic, the polymer network 31 is hydrophobic, so that the polymer network 31 easily separates from the surfaces of the transparent electrodes 12 and 22. As illustrated in FIG. 5B, when the polymer network 31 separates, the liquid crystal droplets 32 in the PNLC layer 30 come into contact with the surfaces of the transparent electrodes 12 and 22, partially changing the interface of the liquid crystal in the PNLC cell. This changes the alignment state of the liquid crystal and disturbs the scattering state, thus generating a recognizable cracked-patterned defect. In particular near the seal 40, components of a sealant (a seal before curing) containing hydrophilic functional groups such as epoxy and hydroxyl groups may dissolve into the PNLC layer 30, so that the polymer network 31, which is hydrophobic, is likely to separate from the surfaces of the transparent electrodes 12 and 22, the polymer network 31 is likely to have an uneven distribution, and a cracked pattern is considered to be easily generated near the seal 40 from the beginning of production.

Based on the prediction, the present inventors studied methods for reducing separation of the polymer network 31. Their studies show that forming a coating film containing a polymer with a polyamic acid structure in the main chain on each of the transparent electrodes 12 and 22 increases the adhesive force of the seal 40 to the substrates and thereby reduce dissolution of the components of the sealant having a hydrophilic functional group into the PNLC layer 30 because the polymer and the sealant (in particular, silane coupling agent in the sealant) are highly compatible with each other. As a result, they found that such a structure can prevent separation of the polymer network 31. Thus, the above issue was successfully solved, and the present invention was completed.

(1) One aspect of the present invention is directed to an optical shutter for camera modules, including: a pair of substrates bonded together with a seal; and a polymer network liquid crystal layer sealed between the substrates, wherein at least one of the substrates includes a transparent electrode made of an oxide conductive film and a coating film covering the transparent electrode and containing a polymer with a polyamic acid structure in a main chain.

(2) In an embodiment of the present invention, the optical shutter includes the structure (1) and the polymer contains a group represented by the following formula (A) in a side chain.

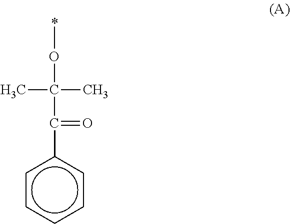

In the formula, * represents a binding site.

(3) In an embodiment of the present invention, the optical shutter includes the structure (1) or (2) and the polymer contains a structure in which a structure derived from a group represented by the following formula (A) and a polymer network in the polymer network liquid crystal layer are bound.

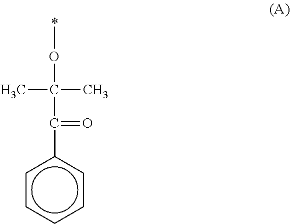

In the formula, * represents a binding site.

(4) In an embodiment of the present invention, the optical shutter includes the structure (1), (2), or (3) and the polymer network liquid crystal layer has a thickness of 10 to 25 μm.

(5) In an embodiment of the present invention, the optical shutter includes the structure (1), (2), (3), or (4) and the oxide conductive film contains indium tin oxide, zinc oxide, or tin oxide.

(6) In an embodiment of the present invention, the optical shutter includes the structure (1), (2), (3), (4), or (5) and the transparent electrode has a thickness of 5 to 50 nm.

(7) In an embodiment of the present invention, the optical shutter includes the structure (1), (2), (3), (4), (5), or (6) and the optical shutter comprises one or more wall members disposed to surround a center of the polymer network liquid crystal layer in a region surrounded by the seal between the substrates.

(8) In an embodiment of the present invention, the optical shutter includes the structure (7) and the wall members are disposed to repeatedly surround the center of the polymer network liquid crystal layer.

(9) Another aspect of the present invention is directed to a method for producing an optical shutter for camera modules, the method including: forming a coating film containing a polymer with a polyamic acid structure in a main chain on a transparent electrode that is made of an oxide conductive film and included in a first substrate; disposing an uncured sealant in a frame shape on the first substrate or a second substrate; dropping a liquid crystal material containing a polymer network forming monomer on the first substrate or the second substrate; overlaying the second substrate on the first substrate via the uncured sealant; and curing the uncured sealant and polymerizing the polymer network forming monomer in the liquid crystal material.

(10) In an embodiment of the present invention, the method includes the process (9), the polymer contains a group represented by the following formula (A) in a side chain, and during curing of the uncured sealant and polymerization of the polymer network forming monomer, a radical generated from the group represented by the following formula (A) in the polymer is reacted with the polymer network forming monomer

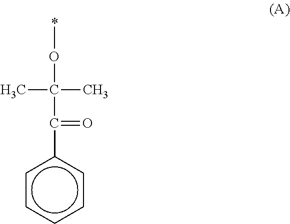

In the formula, * represents a binding site.

(11) In an embodiment of the present invention, the method includes the process (9) or (10) and further includes forming one or more wall members on the first substrate, wherein the uncured sealant is disposed on the first substrate, the liquid crystal material is dropped on the first substrate, and the one or more wall members are disposed in a region to be surrounded by the uncured sealant to surround a position on which the liquid crystal material is to be dropped.

(12) In an embodiment of the present invention, the method includes the process (11), and the wall members are disposed in a region to be surrounded by the uncured sealant to repeatedly surround a position on which the liquid crystal material is to be dropped.

The present invention provides a highly reliable optical shutter for camera modules capable of preventing generation of a streaky transparent portion in a polymer network liquid crystal layer in a scattering state, and a method for producing the optical shutter for camera modules.

### BRIEF DESCRIPTION OF THE DRAWINGS

FIG. 1 is an exemplary schematic cross-sectional view of an optical shutter for camera modules of an embodiment.

FIG. 2 is another exemplary schematic cross-sectional view of the optical shutter for camera modules of the embodiment.

FIG. 3A is an exemplary schematic plan view of the optical shutter for camera modules of the embodiment.

FIG. 3B is another exemplary schematic plan view of the optical shutter for camera modules of the embodiment.

FIG. 3C is another exemplary schematic plan view of the optical shutter for camera modules of the embodiment.

FIG. 4 is a schematic plan view of a cracked-patterned defect that occurred in a conventional optical shutter for camera modules.

FIG. 5A is a schematic cross-sectional view of a conventional optical shutter for camera modules in a normal state.

FIG. 5B is a schematic cross-sectional view of a conventional optical shutter for camera modules in a state with a cracked-patterned defect.

### DETAILED DESCRIPTION OF THE INVENTION

Hereinafter, the present invention is described in further detail based on embodiments with reference to the drawings. The embodiments are not intended to limit the scope of the present invention.

FIG. 1 is an exemplary schematic cross-sectional view of an optical shutter for camera modules of an embodiment. An optical shutter 1 for camera modules of the present embodiment has a structure in which the polymer network liquid crystal (PNLC) layer 30 is disposed between a first substrate 10 and a second substrate 20 bonded together with the seal 40, and the structure is also referred to as a “PNLC cell”. The first substrate 10 has a structure in which a transparent electrode 12 and a coating film 13 containing a polymer with a polyamic acid structure in the main chain are stacked on a transparent substrate 11. Likewise, the second substrate 20 has a structure in which a transparent electrode 22 and a coating film 23 containing a polymer with a polyamic acid structure in the main chain are stacked on a transparent substrate 21. Active elements such as TFTs may be unnecessary on the first substrate 10 and the second substrate 20.

The transparent substrates 11 and 21 may be glass substrates or plastic substrates, for example. The transparent electrodes 12 and 22 are made of oxide conductive films. Alignment of the liquid crystal in the PNLC layer 30 can be controlled by application of voltage across the transparent electrode 12 and the transparent electrode 22. A large number of transparent electrodes 12 and 22 are not required for the optical shutter for camera modules, unlike a liquid crystal cell for a display device that includes many pixel electrodes arranged in a matrix, so that it is preferred to make the transparent electrodes 12 and 22 thin in order to increase transparency in a transmission state instead of making them thick in order to achieve low resistance. Specifically, the transparent electrodes 12 and 22 preferably have a thickness of 5 to 50 nm. If the transparent electrodes 12 and 22 have a thickness of less than 5 nm, the electrodes may not be uniformly formed on the substrates, possibly leaving small regions without electrodes. In such a case, the PNLC layer 30 cannot receive sufficient voltage. In contrast, if the transparent electrodes 12 and 22 have a thickness of more than 50 nm, a decrease in transmittance will be significant due to electrode materials, possibly failing to provide sufficient transmittance in the transmission state.

Examples of the oxide conductive films used in the transparent electrodes 12 and 22 include those containing indium tin oxide, zinc oxide, or tin oxide. In particular, an indium tin oxide (ITO) electrode is suitably used.

The coating films 13 and 23 cover the transparent electrodes 12 and 22, respectively, and each contain a polymer with a polyamic acid structure in the main chain (hereinafter, also referred to as a polyamic acid-based polymer). The carboxyl group in the polyamic acid-based polymer group and the component having a hydrophilic functional group (e.g., an epoxy compound, a hydroxyl group-containing compound, an amine as a curing agent, a silane coupling agent, especially a silane coupling agent) in the sealant (the seal 40 before curing) are highly compatible with each other. Thus, the above structure can increase the adhesive force of the seal 40 to the substrates, preventing the moisture from the outside of the seal 40 and the component having a hydrophilic functional group in the sealant from dissolving into the PNLC layer 30. Thereby, near the seal 40, the hydrophobic polymer network 31 can be in contact with the surfaces of the coating films 13 and 23, the polymer network 31 can be prevented from being distributed unevenly, and occurrence of a cracked-patterned defect in the polymer network liquid crystal layer 30 in a scattering state can be prevented.

In the present embodiment, the high compatibility between the carboxyl group in the polyamic acid in the coating films 13 and 23 and the component having a hydrophilic functional group in the sealant is utilized to increase the adhesive force of the seal 40 to the substrates and prevent occurrence of a cracked-patterned defect. Here, presumably, any polymer other than the polyamic acid can achieve the same effect as long as the polymer has a group highly compatible with the component having a hydrophilic functional group in the sealant. Examples of such a polymer include polyacrylic acid and polymethacrylic acid. Polyacrylic acid and polymethacrylic acid are vinyl-based polymers and have lower hydrophilicity than polyamic acid. These acids are therefore presumed to achieve a smaller effect of increasing the adhesive force of the seal to the substrates and a smaller effect of preventing occurrence of a cracked-patterned defect than polyamic acid.

The coating films 13 and 23 each preferably have a thickness of 10 nm to 500 nm, more preferably 50 nm to 200 nm. If the coating films 13 and 23 each have a thickness of less than 10 nm, they may not be able to completely cover the transparent electrodes 12 and 22, respectively. If the coating films 13 and 23 each have a thickness of more than 500 nm, the coating films 13 and 23 may have a significantly rough surface and thus decrease the transmittance in the transmission state due to scattering on the surfaces of the coating films 13 and 23 and unexpected tilt angles of liquid crystal molecules.

The coating films 13 and 23 and the polyamic acid-based polymer thereof can be alignment films and a polymer thereof usually used in the field of liquid crystal display devices that apply voltage to a liquid crystal layer held between a pair of substrates and thereby control the amount of light transmitted.

The polyamic acid-based polymer has only to have a polyamic acid structure as the main chain of one or more repeat units constituting one molecule of the polymer. The polyamic acid-based polymer may therefore have a polyamic acid structure as the main chain of every repeat unit constituting one molecule of the polymer, or have a polyamic acid structure as the main chain of some repeat units constituting one molecule of the polymer and an imide structure as the main chain of the other repeat units. In the case where the polyamic acid-based polymer has an imide structure, the main chain of more than 0 mol % and 60 mol % or less repeat units among the repeat units constituting one molecule of the polyamic acid-based polymer may be the imide structure. The coating films 13 and 23 may also contain a second polymer that is not a polyamic acid-based polymer, i.e., a second polymer having no polyamic acid structure as the main chain.

The polyamic acid-based polymer preferably has a weight average molecular weight of 1,000 to 1,000,000, more preferably 10,000 to 100,000. With the weight average molecular weight of the polyamic acid-based polymer falling within the above range, a uniform film having the desired thickness can be readily formed. If the polyamic acid-based polymer has a very small weight average molecular weight, a film having the desired thickness is difficult to form. Also, if the thickness is very large, a uniform thickness may be difficult to achieve, leading to noticeable unevenness of the surface. The weight average molecular weight herein can be measured by gel permeation chromatography (GPC).

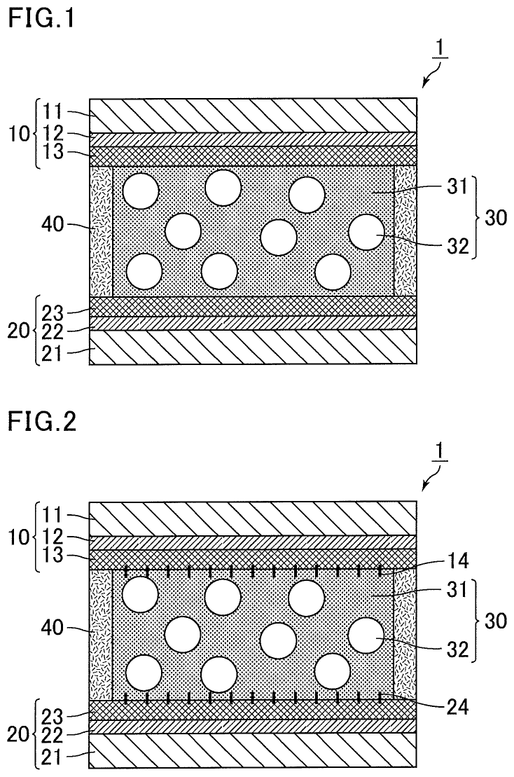

FIG. 2 is another exemplary schematic cross-sectional view of the optical shutter for camera modules of the embodiment. The polyamic acid-based polymer preferably contains a group represented by the following formula (A) in a side chain. As described later, the group represented by the following formula (A) can function as a photo radical polymerization initiator. Hence, in the case where the polyamic acid-based polymer contains the group represented by the following formula (A) in a side chain, the group represented by the following formula (A) can be made to function as a polymerization initiator to form the polymer network 31. At this time, bonds 14 and 24 can be formed between the structure derived from the group represented by the following formula (A) and the polymer network 31. In a polymerization reaction, typically, part of the polymerization initiator remains unreacted. The polyamic acid-based polymer in the optical shutter 1 after the PNLC layer 30 formation therefore typically contains the group represented by the following formula (A) as the unreacted polymerization initiator.

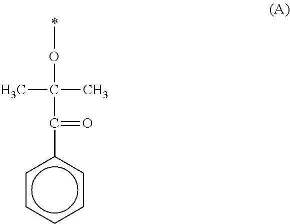

In the formula, * represents a binding site.

Also, as described above, the polyamic acid-based polymer preferably has a structure in which the structure derived from the group represented by the formula (A) and the polymer network 31 in the PNLC layer 30 are bound. This structure can increase the compatibility between the polymer and the polymer network 31 and increase the density of the polymer network 31 near each of the substrates 10 and 20, increasing the degree of scattering. The structure can therefore increase the haze during no voltage application, and further prevent the polymer network 31 from separating from the surface of each of the substrates 10 and 20.

The formation of the bonds 14 and 24 between the structure derived from the group represented by the formula (A) and the polymer network 31 in the PNLC layer 30 in the optical shutter 1 can be examined by the following method.

The optical shutter 1 is broken down into the first substrate 10 and the second substrate 20. The liquid crystal on the first substrate 10 and the second substrate 20 is washed off with a solvent such as hexane. The coating films 13 and 23 are analyzed by time-of-flight secondary ion mass spectrometry (TOF-SIMS). The group represented by the formula (A) can function as a photo radical polymerization initiator as described later. The photo radical polymerization initiator can initiate polymerization of a monomer mainly containing a vinyl group (hereinafter, also referred to as a vinyl monomer). Thus, when a polyamic acid-based polymer containing the group represented by the formula (A) is used in formation of the polymer network 31 through polymerization of a vinyl monomer, the group represented by the formula (A) functions as a polymerization initiator to polymerize the vinyl monomer, forming the polymer network 31 bound to the polyamic acid-based polymer. Vinyl monomers and oligomers are usually washed off with a solvent such as hexane. TOF-SIMS analysis therefore should detect a hydrocarbon group derived from the vinyl group (saturated hydrocarbon group formed when the vinyl group is polymerized) and at least one of an imide group, an amide group, or a carboxyl group in the coating films 13 and 23. Also, mass spectrometry, ¹H-nuclear magnetic resonance (NMR), ¹³C-NMR, or the like analysis should show that the polyamic acid-based polymer in the coating films 13 and 23 contains the group represented by the formula (A). Such results of the analyses show that the group represented by the formula (A) in the polyamic acid-based polymer functioned as an initiator and formed the polymer network, and the structure derived from the group represented by the formula (A) and the polymer network 31 in the PNLC layer 30 formed the bonds 14 and 24. Also, whether or not the bonds are formed between the group represented by the formula (A) in the polyamic acid-based polymer and the polymer network can be determined by collecting the polymer in the coating films 13 and 23, hydrolyzing the polymer, and subjecting the polymer to mass spectrometry and elemental analysis.

The group represented by the formula (A) is cleaved when irradiated with ultraviolet light and can generate two radicals, namely *-O—C(CH₃)₂. and .CO—C₆H₅, and thereby functioning as a photo radical polymerization initiator. Here, the symbol “.” represents a radical. The group represented by the formula (A) is also referred to as an initiator functional group.

In the case where the polyamic acid-based polymer contains the group represented by the formula (A), the group represented by the formula (A), when cleaved under ultraviolet light, generates radicals in a side chain of the polyamic acid-based polymer. The radicals react with a monomer (e.g., vinyl group-containing monomer) added to form the polymer network 31 in the PNLC layer 30 and initiate radical polymerization of the monomer. As the monomer is polymerized, the polymer network 31 is formed. In this manner, the structure represented by ^{*-O—C(CH}₃)₂— remains as the structure derived from the group represented by the formula (A) in the side chain of the polyamic acid-based polymer, and a covalent bond is formed between carbon in the structure and the polymer network 31 in the PNLC layer 30.

The group represented by the formula (A) is preferably contained in a side chain of the polyamic acid-based polymer. Basically, the polyamic acid-based polymer in the coating films 13 and 23 is highly compatible with the transparent electrodes 12 and 22 made of a material such as ITO and is in contact with the transparent electrodes 12 and 22. Thus, in the case where the group represented by the formula (A) is contained in the main chain of the polyamic acid-based polymer, the average distance between the group represented by the formula (A) and the later-described polymer network forming monomer increases and the polymerization initiation efficiency to initiate polymerization of the polymer network forming monomer decreases in production of the optical shutter 1. The group represented by the formula (A) is therefore preferably contained in a side chain of the polyamic acid-based polymer.

The PNLC layer 30 has a structure in which the liquid crystal droplets 32 are in the polymer network (also referred to as “polymer matrix”) 31. The ratio between the polymer network 31 and the liquid crystal droplets 32 in the PNLC layer 30 is not particularly limited. Yet, in a mode with more liquid crystal droplets (e.g., mode with a network of polymer molecules in the liquid crystal layer), a streaky transparent portion is more likely to be generated in the PNLC layer 30 in a scattering state. The present embodiment can effectively prevent generation of a streaky transparent portion in such a mode.

The polyamic acid-based polymer preferably has at least one structure represented by the following formula (PA). Here, the PNLC layer 30 scatters light when the difference in refractive index between the polymer network 31 and the liquid crystal droplets 32 is large, while transmitting light when the difference is small. The refractive index of the polymer network 31 in the PNLC layer 30 is relatively large. The refractive index of the liquid crystal droplets 32 decreases as the alignment direction of the liquid crystal molecules becomes more horizontal to the substrates 10 and 20 and the refractive index increases as the alignment direction becomes more vertical to the substrates 10 and 20. When the polyamic acid-based polymer has at least one structure represented by the following formula (PA), the tilt angle of the liquid crystal molecules can be minimized and the refractive index of the liquid crystal droplets 32 can be reduced by aligning the liquid crystal molecules in the direction substantially parallel to the substrates 10 and 20 when no voltage is applied. As a result, the refractive index of the liquid crystal droplets 32 when voltage is applied can be further increased from the refractive index of the liquid crystal droplets 32 when no voltage is applied, so that the transmittance when voltage is applied (in the transmission state) can be further increased from the transmittance when no voltage is applied.

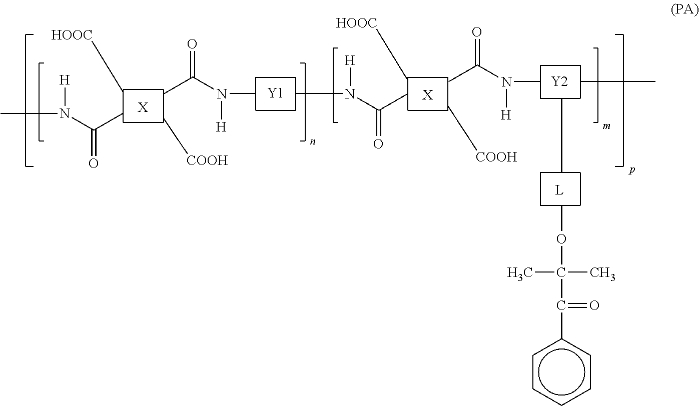

In the formula, X is a group represented by the following formula (X-1); Y1 is a group represented by the following formula (Y1-1) or (Y1-2); Y2 is a group represented by the following formula (Y2-1) or (Y2-2); L is —(CH₂)_{q}—CO— (where q is 0, 1, 2, or 3); m, n, and p are each independently an integer of 1 or greater; and m and n satisfy 0<m/(m+n)<1.

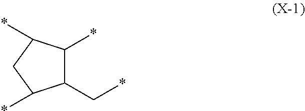 [SMILES: *CC1C(*)CC(*)C1*]

In the formula, * represents a binding site.

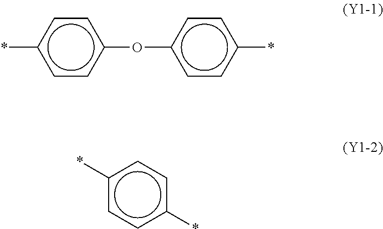

In the formulas, * represents a binding site.

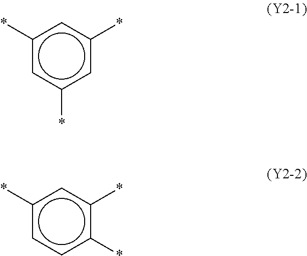

In the formulas, * represents a binding site.

The ratio m/(m+n) in the formula (PA) represents a copolymerization ratio and satisfies 0<m/(m+n)<1, preferably 0.2 m/(m+n) 0.8. If the ratio m/(m+n) in the formula (PA) is less than 0.2, the polymerization initiation efficiency to initiate polymerization of the later-described polymer network forming monomer may decrease. If the ratio m/(m+n) in the formula (PA) is more than 0.8, the liquid crystal molecules may be at a slight tilt angle, slightly decreasing the transmittance in the transmission state.

The polymer network 31 can be formed by irradiating a polymer network forming monomer dissolved in the liquid crystal material with ultraviolet light to polymerize the monomer. The polymer network forming monomer may be an acrylic monomer, for example. Liquid crystal molecules in the liquid crystal droplets 32 scatter light when no voltage is applied. When voltage is applied across the transparent electrodes 12 and 22 disposed to face each other with the PNLC layer 30 therebetween, the liquid crystal molecules align in one direction according to the electric field to allow transmission of light. In other words, it is possible to switch between the scattering state and transmission state by applying or not applying voltage across the transparent electrodes 12 and 22.

In the case where the polyamic acid-based polymer contains the group represented by the formula (A), the polymer network forming monomer can be polymerized with the group represented by the formula (A) as the polymerization initiator, so that the polymer network 31 can be formed. In the case where the polyamic acid-based polymer contains no group represented by the formula (A), a polymerization initiator can be separately added to the liquid crystal material to polymerize the polymer network forming monomer. In the case where the polyamic acid-based polymer contains the group represented by the formula (A), a polymerization initiator may be added separately to the liquid crystal material. A suitable polymerization initiator to be added separately to the liquid crystal material is a photo radical polymerization initiator.

The PNLC layer 30 preferably has a thickness (cell thickness) of 10 to 25 μm. If the PNLC layer 30 has a thickness of less than 10 μm, the scattering intensity is reduced, so that the optical shutter for camera modules may not have desired light-shielding properties. If the PNLC layer 30 has a thickness of more than 25 μm, the PNLC layer 30 has slow switching response, so that the optical shutter for camera modules may not have desired responsivity. The PNLC layer 30 more preferably has a thickness of approximately 15 μm. The PNLC cell is thicker than general liquid crystal cells (about 5 μm) for display devices. Thus, stress resulting from formation of the polymer network 31 and curing of the sealant during the production and from thermal cycles in the reliability test tends to be high, which is considered to be one of the factors that cause a cracked-patterned defect.

The seal 40 is a sealing member disposed between the first substrate 10 and the second substrate 20 to bond these substrates together with a predetermined gap therebetween. The seal 40 is disposed in a frame shape along the edges of the first substrate 10 and the second substrate 20, and the PNLC layer 30 is sealed in the space surrounded by the first substrate 10, the second substrate 20, and the seal 40. The seal 40 can be formed by applying a sealant with a dispenser or the like and curing the sealant.

The sealant preferably contains a component containing a hydrophilic functional group. When the sealant contains a component containing a hydrophilic functional group, the component containing a hydrophilic functional group in the resulting seal is likely to dissolve into the PNLC layer to cause a cracked pattern. Meanwhile, the present embodiment can effectively prevent generation of a cracked-patterned defect in the polymer network liquid crystal layer 30 in a scattering state by increasing the adhesive force of the seal 40 to the substrates owing to the high compatibility between the carboxyl group in the polyamic acid in the coating films 13 and 23 and the component containing a hydrophilic functional group in the sealant.

Examples of the component containing a hydrophilic functional group include epoxy compounds, hydroxyl group-containing compounds, amines as curing agents, silane coupling agents, carboxyl group-containing compounds, and sulfone group-containing compounds.

Examples of the sealant containing the component containing a hydrophilic functional group include sealants containing an epoxy compound. The sealant containing an epoxy compound is a thermosetting sealant curable by heat. The sealant containing an epoxy compound contains, as well as the epoxy compound, a component containing a hydrophilic functional group, such as a hydroxyl group-containing compound, an amine as a curing agent, a silane coupling agent, a carboxyl group-containing compound, or a sulfone group-containing compound.

The sealant may also contain a different component other than the component containing a hydrophilic functional group. The different component may be, for example, an acrylic monomer. An acrylic monomer is curable by ultraviolet light. Accordingly, for example, mixing an acrylic monomer and a photopolymerization initiator with a sealant containing an epoxy compound enables curing of the sealant by ultraviolet light and heat.

The sealant is preferably one that is cured by heat, ultraviolet light, or ultraviolet light and heat, more preferably one that is cured by ultraviolet light and heat (ultraviolet light- and heat-curable one). With the use of a sealant that is cured by ultraviolet light, it is possible to cure the sealant and form the polymer network 31 simultaneously by ultraviolet light irradiation.

The predetermined gap (gap between the first substrate 10 and the second substrate 20) is controlled by spacers (not illustrated). Examples of the spacers include plastic beads and photospacers. Plastic beads may be mixed into the sealant. Photo spacers can be formed by patterning photosensitive resin (resist) by photolithography.

Although not illustrated in FIGS. 1 and 2, at least one wall member may be disposed to surround the center of the PNLC layer 30 in the region surrounded by the seal 40 between the first substrate 10 and the second substrate 20. The at least one wall member is also referred to as a “stopper wall” because it is disposed in order to protect the uncured sealant from pressure of the liquid crystal material. In the case of providing the PNLC layer 30 by one drop filling (ODF) method, the sealant is applied with a dispenser or like, the liquid crystal material containing the polymer network forming monomer is dropped onto the first substrate 10 or the second substrate 20 (one of the substrates) to which the second substrate 20 or the first substrate 10 (the other substrate) is then bonded. As the substrates are bonded together, the liquid crystal material is spread out to fill the region surrounded by the seal 40. In the case where the method that simultaneously cures the sealant and forms the polymer network 31 is used, the sealant is in an uncured state at the time of bonding. Thus, due to the pressure of the liquid crystal material spread out, a missing part may be generated in the arrangement pattern of the frame shape of the sealant. Therefore, the stopper wall is disposed between the dropping position of the liquid crystal material and the sealant so as to protect the uncured sealant from the pressure of the liquid crystal material. The stopper wall is preferably disposed outside a region where the transparent electrodes 12 and 22 are disposed (hereinafter such a region is also referred to as an “active area”). The arrangement pattern of the stopper wall is not particularly limited. For example, a stopper wall having a frame shape may be disposed, or multiple linear stopper walls may be disposed in a frame shape. The height of the stopper wall is preferably 0.8 to 1 times, more preferably 0.95 to 1 times the cell thickness of the PNLC cell. If the height of the stopper wall is less than 0.8 times the cell thickness, the monomer-containing liquid crystal material is more likely to contact the uncured sealant. In contrast, if the height of the stopper wall is greater the cell thickness (thickness of the PNLC layer 30), the cell thickness may not be appropriately controlled.

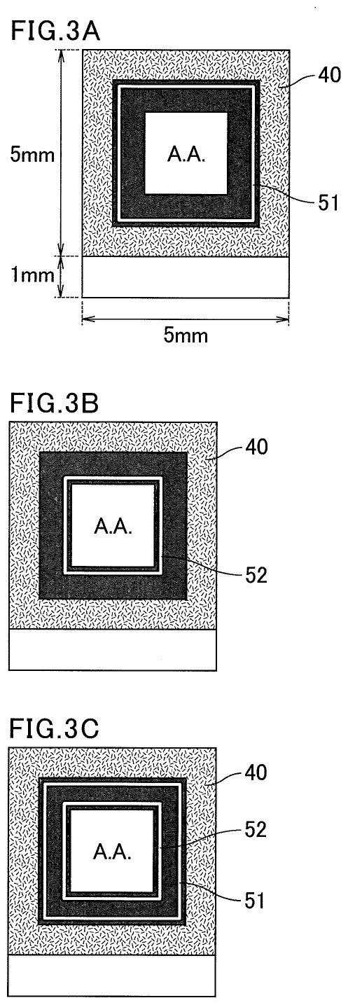

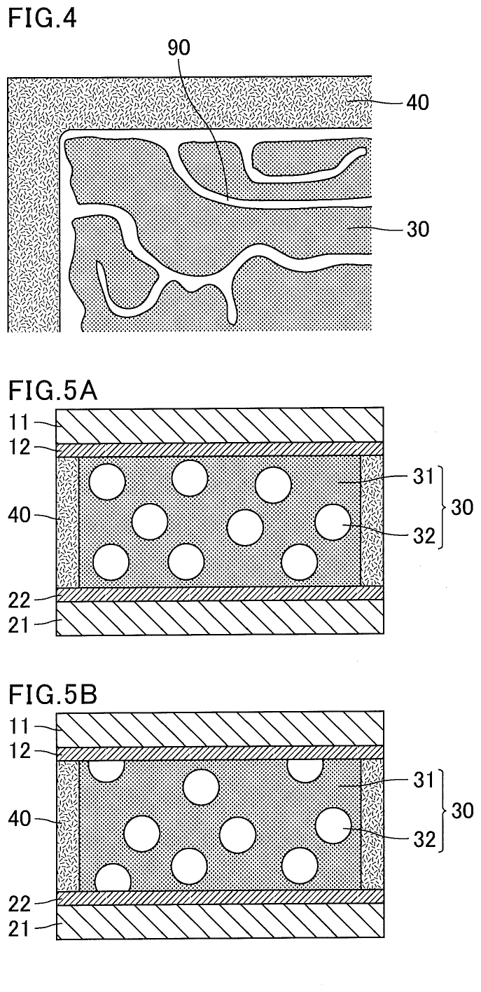

FIGS. 3A to 3C each illustrate an exemplary schematic plan view of the optical shutter for camera modules of the embodiment. FIGS. 3A to 3C are different in stopper wall arrangement. As illustrated in FIG. 3A, a stopper wall 51 may be disposed near the seal 40. The stopper wall 51 is disposed 0.1 to 0.5 mm away from the inner boundary of the seal 40, for example. Alternatively, as illustrated in FIG. 3B, a stopper wall 52 may be disposed near the active area (A. A.). The stopper wall 52 is disposed 0.1 to 0.5 mm away from the outer boundary of the active area (A. A.). Further, as illustrated in FIG. 3C, both the stopper wall 51 and the stopper wall 52 may be disposed. In other words, the stopper walls may be disposed to surround the center of the PNLC layer 30 two times or three times or more.

In the example illustrated in FIGS. 3A to 3C, the substrate to which the sealant is applied has a size of 6 mm×5 mm. A light shielding area having a width of 0.3 to 1 mm is disposed in a frame shape to surround the active area (A. A.), and the seal 40 having dimensions of 5 mm×5 mm with a width of 0.3 to 1.2 mm is formed in a frame shape to surround the light shielding area. The stopper wall 51 and/or the stopper wall 52 are/is disposed so as to surround the active area (A. A.) in the light shielding area.

The stopper walls 51 and 52 can be formed on the first substrate 10 or the second substrate 20 using photosensitive resin (resist) by photolithography. The stopper walls 51 and 52 may be formed simultaneously with photospacers that are disposed between the first substrate 10 and the second substrate 20 in order to control the cell thickness.

The method for producing the optical shutter 1 of the present embodiment is not particularly limited, but preferably includes the following steps (1) to (5):
(1) forming a coating film containing a polymer with a polyamic acid structure in the main chain (polyamic acid-based polymer) on the transparent electrode 12 that is made of an oxide conductive film and included in the first substrate 10;
(2) disposing an uncured sealant in a frame shape on the first substrate 10 or the second substrate 20;
(3) dropping a liquid crystal material containing a polymer network forming monomer on the first substrate 10 or the second substrate 20;
(4) overlaying the second substrate 20 on the first substrate 10 via the uncured sealant and the liquid crystal material; and
(5) curing the uncured sealant and polymerizing the polymer network forming monomer in the liquid crystal material.

The polyamic acid-based polymer contains the group represented by the formula (A) in a side chain, and the radicals generated from the group represented by the formula (A) in the polymer are preferably reacted with the polymer network forming monomer in the curing of the sealant and polymerizing of the monomer. This structure can increase the compatibility between the polyamic acid-based polymer and the polymer network 31 and increase the density of the polymer network 31 near the substrate, increasing the degree of scattering. The structure can therefore increase the haze during no voltage application, and further prevent the polymer network 31 from separating from the surfaces of the substrates (substrates 10 and 20).

Step (2) is preferably a step of disposing an uncured sealant in a frame shape on the first substrate 10. Step (3) is preferably a step of dropping a liquid crystal material containing a polymer network forming monomer in a region that is surrounded by the uncured sealant and includes the coating film on the first substrate 10. This structure can prevent the liquid crystal material from flowing out of the region surrounded by the sealant.

Step (5) is preferably performed by ultraviolet light irradiation. This enables curing of the sealant and formation of the polymer network 31 simultaneously by a simple method.

The polymer network forming monomer preferably contains at least one radically polymerizable group. With such a polymer network forming monomer and the polymer containing the group represented by the formula (A) in a side chain, radicals generated from the group represented by the formula (A) under ultraviolet light and the polymer network forming monomer can be reacted, so that bonds can be formed between the polymer and the polymer network 31.

The polymer network forming monomer more preferably contains two or more radically polymerizable groups. When unreacted monomers remain in the polymer network, the charge retention characteristics (voltage holding ratio) may deteriorate or an electrical double layer may be easily formed due to the DC offset component of the applied voltage, easily generating residual DC. Almost all of such unreacted monomers can be eliminated when the polymer network forming monomer contains two or more radically polymerizable groups as the polymerization rate of the radical polymerization significantly increases. This can prevent deterioration of charge retention characteristics and generation of residual DC.

The radically polymerizable group is preferably a group containing a vinyl group. Examples of the radically polymerizable group include acrylate and methacrylate groups.

Examples of the polymer network forming monomer include monomers represented by the following formulas (M1) to (M4).

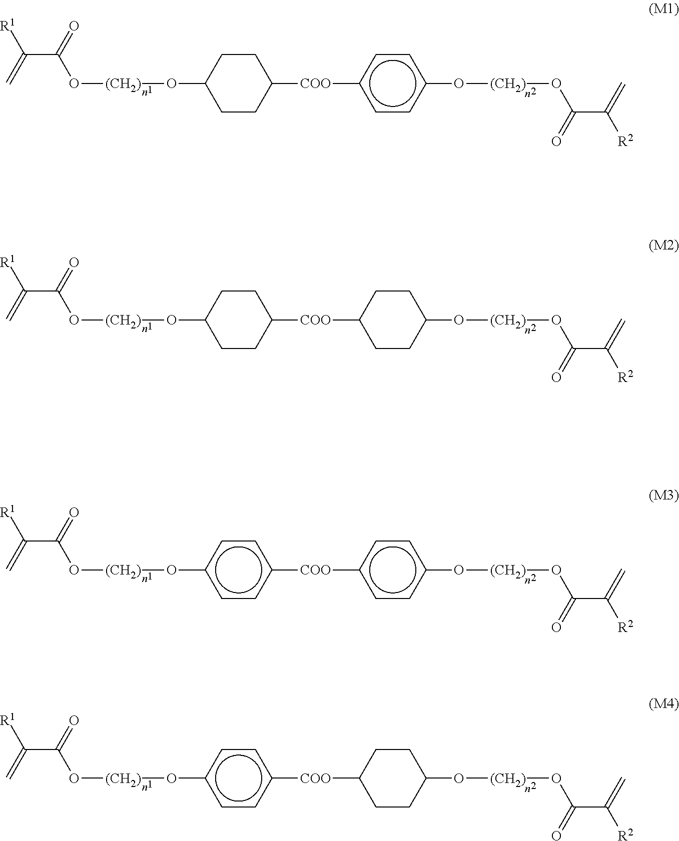

In the formulas, R¹ and R² are the same as or different from each other and each represent a hydrogen atom or a methyl group (preferably a methyl group), and n¹ and n² are the same as or different from each other and each represent an integer of 0 to 20 (preferably an integer of 2 to 12, more preferably an integer of 4 to 8).

The method for producing an optical shutter for camera modules of the present embodiment may include step (6) of forming at least one wall member (the stopper wall 51 and/or the stopper wall 52) on the first substrate 10. Step (6) preferably precedes step (1). One or more wall members are preferably disposed to surround the dropping position of the liquid crystal material in the region to be surrounded by the uncured sealant. This makes it possible to protect the uncured sealant from pressure of the liquid crystal material that is spread in step (4). The wall members may be disposed to repeatedly surround the dropping position of the liquid crystal material in the region to be surrounded by the uncured sealant.

For use, the optical shutter for camera modules of the present embodiment is incorporated into a camera module. The optical shutter may be an optical shutter disposed on the light-emitting side or an optical shutter disposed on the light-receiving side. The optical shutter that is disposed on the light-emitting side is used to control transmission and blockage of light emitted by a light source. The optical shutter that is disposed on the light-receiving side is used to control transmission and blockage of light incident on a light receiving unit such as a light receiving element. The camera module may include multiple optical shutters of the present embodiment, or the optical shutter of the present embodiment may include multiple active areas. The light to be controlled by the optical shutter is not limited to visible light and may be infrared light or ultraviolet light. The camera module is used, for example, in a digital camera, a smartphone, or a tablet personal computer.

The present invention is described in further detail below with reference to examples and comparative examples, but the present invention is not limited to these examples.

### SYNTHETIC EXAMPLE 1

A synthesis example of a diamine monomer containing the group represented by the formula (A) in a side chain is shown below.

### Process A

An amount of 3 g of dinitrophenyl acetate (13.3 mmol, compound (1)) was dissolved in 8 mL of SOLMIX AP-I, followed by addition of 0.06 g of Raney Ni to the solution. The mixture was fed into an autoclave. The system was purged with hydrogen and left to stand overnight at room temperature under a pressure of 0.4 MPa. High performance liquid chromatography (HPLC) was used to confirm that the reaction was completed, and then the reaction liquid was filtered through Celite. The filtrate was concentrated until no filtrate was observed. The thus-obtained crude liquid was distilled under reduced pressure, so that 1.98 g of 2,4-diaminophenyl acetate (2) (11.9 mmol, yield: 90%) was obtained. Then, 1.8 g of the compound (2) (10.8 mmol) was dissolved in 5 mL of acetone, followed by dropwise addition of t-butoxycarbonyl anhydride (5 g/THF 5 mL) into the solution. The resulting mixture was heated to the reflux temperature and left to stand overnight. After the completion of the reaction, the reaction liquid was concentrated and dried, whereby a Boc compound (3) (3.73 g, 10.2 mmol, yield: 94%) was obtained.

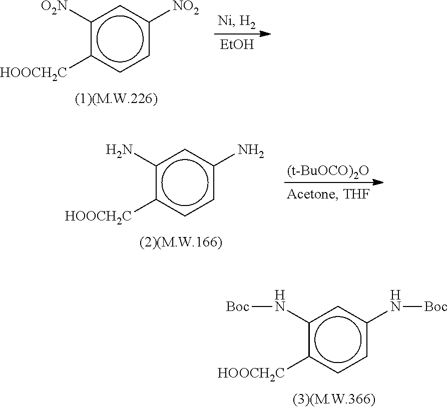

### Process B

Into a benzene solution (30 mL) containing 3.5 g (9.56 mmol) of the Boc compound (3) was dropwise added thionyl chloride, so that an acid chloride compound represented by the following formula (4) (3.42 g, 8.89 mmol, yield: 93%) was synthesized. Into a benzene solution (30 mL) containing 1.64 g (10 mmol) of 2-hydroxy-2-methyl-1-phenyl-propan-1-one represented by the following formula (5) and 1.5 g (15 mmol) of triethylamine was dropwise added a benzene solution (20 mL) containing 3.3 g (8.5 mmol) of the acid chloride compound represented by the following formula (4) at room temperature in a nitrogen atmosphere. The mixture was reacted for two hours at room temperature. After the completion of the reaction, impurities were extracted with water, and the residue was purified by column chromatography (toluene/ethyl acetate (4/1)), whereby 4.10 g of the target compound represented by the following formula (6) was obtained (yield: 80%).

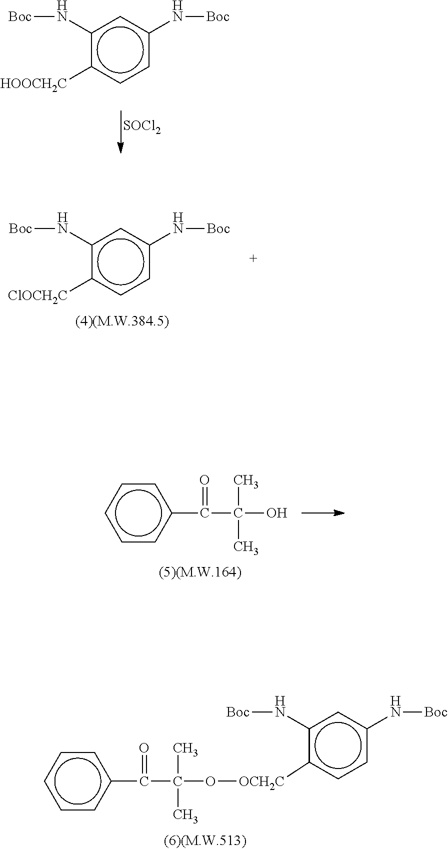

### Process C

The compound represented by the formula (6) was dissolved in methylene chloride, followed by adding tin(II) trifluoromethanesulfonate (Sn(OTf)₂) in portions to the solution at 0° C. The mixture was reacted at room temperature, and then neutralized with 5% NaHCO₃aq. The mixture was washed with water until it had a neutral pH. The organic layer was dried over anhydrous magnesium sulfate and filtered through Celite. The filtrate was concentrated, whereby the target diamine monomer represented by the following formula (7) (1.92 g, 6.16 mmol, yield: 77%) was obtained.

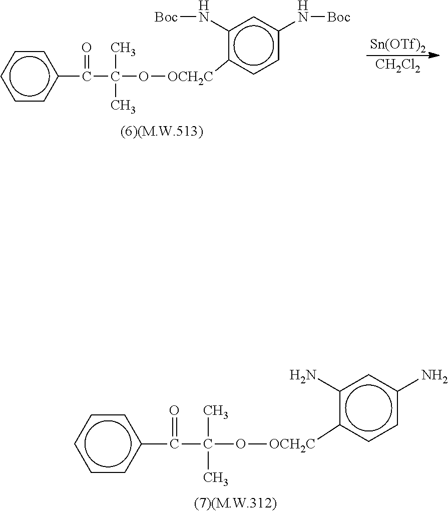

### CONDENSATION POLYMERIZATION EXAMPLE 1

The following shows an exemplary synthesis of a polymer that has introduced therein 40 mol % of the diamine unit containing a polyamic acid structure in the main chain and the group represented by the formula (A) in a side chain.

The following acid anhydride (0.10 mol) was added to a γ-butyrolactone solution containing the following diamine DA1 (0.06 mol) and the following diamine DA2 (diamine containing the group represented by the formula (A) in a side chain; 0.04 mol), and the mixture was reacted at 60° C. for 12 hours, whereby a polyamic acid having a random structure (polymer containing a polyamic acid structure in the main chain and the group represented by the formula (A) in a side chain) was obtained.

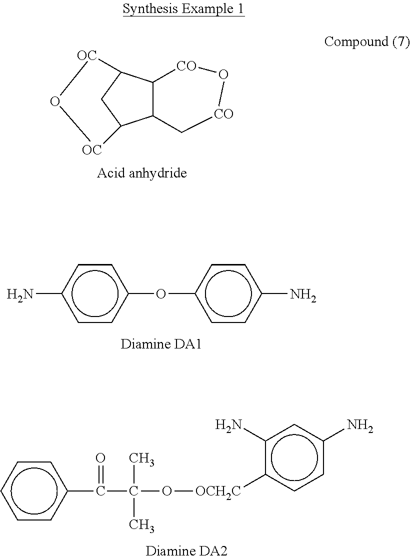

### CONDENSATION POLYMERIZATION EXAMPLE 2

The following shows an exemplary synthesis of a polymer that has introduced therein 40 mol % of the diamine unit containing a polyamic acid structure in the main chain and the group represented by the formula (A) in a side chain.

The following acid anhydride (0.10 mol) was added to a γ-butyrolactone solution containing the following diamine DA3 (0.06 mol) and the following diamine DA2 (diamine containing the group represented by the formula (A) in a side chain; 0.04 mol), and the mixture was reacted at 60° C. for 12 hours, whereby a polyamic acid having a random structure (polymer containing a polyamic acid structure in the main chain and the group represented by the formula (A) in a side chain) was obtained.

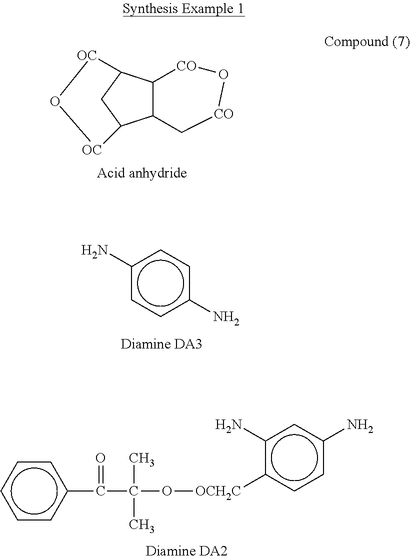

### EXAMPLE 1-2

A PNLC cell for an optical shutter device was produced by the following method.

Two colorless and transparent glass substrates were prepared, each including a 30-nm thick ITO electrode on one of its surfaces. Each of the two substrates was subjected to the following treatments. Here, one of the two glass substrates included columnar photospacers having a height of 15 μm and a stopper wall having a height of 15 μm illustrated in FIG. 3A, on the surface where the ITO electrode was formed.

First, a polymer (polyamic acid-based polymer) containing a polyamic acid structure in the main chain and the group represented by the formula (A) in a side chain and produced by the same procedure as in Condensation Polymerization Example 1 was applied to the surface of the ITO electrode on each of the two substrates by spin coating. The substrates were pre-baked at 90° C. for one minute and post-baked at 200° C. for 10 minutes, so that coating films each having a thickness of 100 nm was formed. The introduction amount r of the diamine unit containing the group represented by the formula (A) in a side chain in the polyamic acid-based polymer was 20 mol %. The post-baking at 200° C. partially imidized the polyamic acid-based polymer and thereby caused the polyamic acid-based polymer to have an imide structure in the main chain.

Subsequently, a sealant (“Photolec” available from Sekisui Chemical Co., Ltd.) curable by ultraviolet light and heat was applied in a specific pattern with a dispenser to the surface of only one of the two substrates. After application, a PNLC material (DIC Corporation) was dropped onto the substrate. The PNLC material contained a monomer containing a vinyl group represented by the formula (M1) (wherein n¹ and n² are each 4 and R¹ and R² are each a methyl group) as the polymer network forming monomer. The host liquid crystal had a Tni (nematic-isotropic phase transition temperature) of 70° C., a An (refractive index anisotropy) of 0.2, and a Δε (anisotropy of dielectric constant) of 8. The PNLC material contained no polymerization initiator. The host liquid crystal is a liquid crystal compound component other than the polymer network forming monomer in the PNLC material. Typically, the characteristics of a device (e.g., optical shutter for camera modules) in practical use are considered to depend mainly on the physical values of the host liquid crystal.

Subsequently, the other substrate was bonded to the substrate, and the substrates were irradiated with ultraviolet light having a wavelength of 365 nm at 18° C. with an intensity of 2.5 J/cm² to simultaneously cure the sealant and polymerize the monomer in the PNLC material (form a polymer network). Here, the group represented by the formula (A) in a side chain of the polyamic acid-based polymer is decomposed under ultraviolet light to generate radicals, and the radicals are presumed to react with the polymer network forming monomer and initiate polymerization of the monomer. Thus, presumably, the polyamic acid-based polymer in the coating film and the polymer network are chemically bound to each other. Subsequently, the substrates were heated in a 130° C. oven for one hour to completely cure the sealant.

Thus, a PNLC cell including a PNLC layer between the paired substrates bonded with the cured sealant (seal) was completed. The PNLC cell was able to apply voltage to the PNLC layer through the ITO electrodes provided on the two substrates, and functioned as an optical shutter that switches between the scattering state during no voltage application and the transmission state during voltage application.

### EXAMPLES 1-1, 1-3 to 1-5

PNLC cells of Examples 1-1, 1-3, 1-4, and 1-5 were produced as in Example 1-2, except that the introduction amount r of the diamine unit containing the group represented by the formula (A) in the polyamic acid-based polymer was changed to 0 mol %, 40 mol %, 60 mol %, and 80 mol %, respectively. In Example 1-1, 0.05 wt % of a photo radical polymerization initiator was separately added to the PNLC material.

### COMPARATIVE EXAMPLE 1

A PNLC cell of Comparative Example 1 was produced as in Example 1-2, except that no coating film was formed and 0.05 wt % of a photo radical polymerization initiator was separately added to the PNLC material.

### <Evaluation Method>

The following evaluation tests were performed on the PNLC cells produced in Examples 1-1 to 1-5 and Comparative Example 1. Table 1 tabulates the obtained results.

### (Observation for Presence or Absence of Cracked Pattern)

Whether or not the PNLC cell during no voltage application exhibited a streaky transparent portion (cracked pattern) was checked by visual observation with a microscope.

### (Haze)

The haze of the PNLC cell during no voltage application was measured at 25° C. using “NDH 7000” available from Nippon Denshoku Industries Co., Ltd.

### (Response Characteristics)

Using “Photal 5200” available from Otsuka Electronics Co., Ltd., response characteristics of the PNLC cell was measured between 0.5 V and 20 V at 25° C. to check rising response time (0.5 V→20 V) and falling response time (20 V→0.5 V).

### (Aging Test)

The PNLC cell was stored in a −20° C. oven for 500 hours (500 h), and then observed for the presence or absence of a cracked pattern in the same manner as described above.

TABLE 1

| | | Introduction amount r | | | | | |
|---|---|---|---|---|---|---|---|
| | | of diamine unit | Initial state | | | | |
| | | containing group | | | Rising | Falling | After 500-hour |
| | | represented by formula | | | response | response | aging |
| | Polymer in coating film | (A) | Cracked pattern | Haze (%) | time (ms) | time (ms) | Cracked pattern |
| Example 1-1 | Condensation Polymerization Example 1 | 0 mol % | Absent | 90 | 2.4 | 5.9 | Absent |
| | With polyamic acid structure | | | | | | |
| Example 1-2 | Condensation Polymerization Example 1 | 20 mol % | Absent | 92 | 2.4 | 6.3 | Absent |
| | With polyamic acid structure | | | | | | |
| Example 1-3 | Condensation Polymerization Example 1 | 40 mol % | Absent | 92 | 2.2 | 6.1 | Absent |
| | With polyamic acid structure | | | | | | |
| Example 1-4 | Condensation Polymerization Example 1 | 60 mol % | Absent | 92 | 2.1 | 6.1 | Absent |
| | With polyamic acid structure | | | | | | |
| Example 1-5 | Condensation Polymerization Example 1 | 80 mol % | Absent | 92 | 2.3 | 6.0 | Absent |
| | With polyamic acid structure | | | | | | |
| Comparative | — | — | Present (near | 91 | 2.2 | 6.1 | Present |
| Example 1 | | | seal) | | | | (expanded) |

As is clear from Examples 1-1 to 1-5, when the coating films containing the polyamic acid-based polymer were formed on the ITO electrodes, no cracked pattern (defect) was observed near the seal in either the initial state or after the aging test at 70° C. for 500 hours. These results suggest that formation of the coating films containing the polyamic acid-based polymer on the surfaces of the substrates increases the adhesion between the coating films and the seal, resulting in no (or reduced) entry of moisture from the outside of the cell and dissolution of the seal components into the liquid crystal layer and no observation of a cracked pattern in either the initial state or after the aging for 500 hours.

In contrast, when no coating film containing the polyamic acid-based polymer was formed (Comparative Example 1), a cracked pattern was observed near the seal in the initial state, and the cracked pattern expanded after the aging test at −20° C. These results suggest that a cracked pattern was observed because in Comparative Example 1 with no polyamic acid-based polymer, the adhesion between the substrates and the seal was insufficient, the seal components and the moisture from the outside dissolved into the liquid crystal layer, and the adhesive force of the polymer network to the substrates was low.

In Examples 1-1 to 1-5 with the polyamic acid-based polymer, the haze was slightly low when the polymer network was not bound to the coating films (in Example 1-1 in which the introduction amount r of the diamine unit containing the group represented by the formula (A) was 0 mol %). This is presumably because the low compatibility between the polyamic acid-based polymer and the polymer network slightly decreased the density of the polymer network near the substrates, thereby slightly decreasing the degree of scattering. When the polyamic acid-based polymer contains the group represented by the formula (A) in a side chain, the haze during no voltage application can also be increased.

Although the polyamic acid-based polymer was used in each of Examples 1-1 to 1-5, a cracked pattern occurred after about 1500 hours in Example 1-1 with the polymer network not bound to the coating films and no cracked pattern occurred until after 3000 hours in Examples 1-2 to 1-5 with the polymer network bound to the coating films. This is presumably because in Examples 1-2 to 1-5, since the coating films and the polymer network are bound to each other, the adhesive force of the polymer network to the substrates was high, so that a cracked pattern was less likely to occur.

### EXAMPLES 2-1 to 2-5

PNLC cells of Examples 2-1 to 2-5 were produced as in Examples 1-1 to 1-5, except that a polymer (polyamic acid-based polymer) containing a polyamic acid structure in the main chain synthesized by the same procedure as in Condensation Polymerization Example 2 was used, and the post-baking after application of the polyamic acid-based polymer to the surfaces of the ITO electrodes was performed at 180° C. for 20 minutes. The polyamic acid-based polymer used in each of Examples 2-1 to 2-5 was a polymer containing a polyamic acid structure in the main chain. The polyamic acid-based polymer used in each of Examples 2-2 to 2-5 further contained the group represented by the formula (A) in a side chain.

### <Evaluation Method>

The evaluation test was performed on the PNLC cells produced in Examples 2-1 to 2-5. Table 2 tabulates the obtained results.

TABLE 2

| | | Introduction amount r | Initial state | | | | |
|---|---|---|---|---|---|---|---|
| | | of diamine unit containing | | | Rising | Falling | After 500-hour |
| | | group represented by | | Haze | response | response | aging |
| | Polymer in coating film | formula (A) | Cracked pattern | (%) | time (ms) | time (ms) | Cracked pattern |
| Example 2-1 | Condensation Polymerization Example 2 | 0 mol % | Absent | 89 | 2.4 | 6.2 | Absent |
| | With polyamic acid structure | | | | | | |
| Example 2-2 | Condensation Polymerization Example 2 | 20 mol % | Absent | 91 | 2.3 | 6.2 | Absent |
| | With polyamic acid structure | | | | | | |
| Example 2-3 | Condensation Polymerization Example 2 | 40 mol % | Absent | 92 | 2.1 | 6.1 | Absent |
| | With polyamic acid structure | | | | | | |
| Example 2-4 | Condensation Polymerization Example 2 | 60 mol % | Absent | 91 | 2.1 | 6.1 | Absent |
| | With polyamic acid structure | | | | | | |
| Example 2-5 | Condensation Polymerization Example 2 | 80 mol % | Absent | 92 | 2.2 | 6.0 | Absent |
| | With polyamic acid structure | | | | | | |
| Comparative | — | — | Present (near | 91 | 2.2 | 6.1 | Present |
| Example 1 | | | seal) | | | | (expanded) |

As in Examples 1-1 to 1-5, the adhesion between the coating films and the seal was increased by formation of the coating films containing the polyamic acid-based polymer on the ITO electrodes in Examples 2-1 to 2-5, so that no cracked pattern (defect) was observed. Also, when the polyamic acid-based polymer contained the group represented by the formula (A) in a side chain (Examples 2-2 to 2-5), the haze during no voltage application was increased. Moreover, in Examples 2-2 to 2-5, the coating film and the polymer network were bound to each other and thus the adhesive force of the polymer network to the substrates was higher than that in Example 2-1, so that a cracked pattern was less likely to occur.

### EXAMPLES 3-1 to 3-5

PNLC cells of Examples 3-1, 3-2, 3-3, 3-4, and 3-5 were produced as in Example 1-3, except that the heights of the photospacers and the stopper wall(s) were changed to 5 mm, 10 mm, 20 mm, 25 mm, and 30 mm, respectively. The polymer used in each of Examples 3-1 to 3-5 was a polymer containing the polyamic acid structure in the main chain and the group represented by the formula (A) in a side chain (polyamic acid-based polymer). The introduction amount r of the diamine unit containing the group represented by the formula (A) was 40 mol % in all the polyamic acid-based polymers in Examples 3-1 to 3-5.

The evaluation test was performed on the PNLC cells produced in Examples 3-1 to 3-5. Table 3 tabulates the obtained results.

TABLE 3

| | | | Initial state | | | | |
|---|---|---|---|---|---|---|---|
| | | | | | Rising | Falling | After 500-hour |
| | | Height of | Cracked | | response | response | aging |
| | Polymer in coating film | photospacers | pattern | Haze (%) | time (ms) | time (ms) | Cracked pattern |
| Example 3-1 | Condensation Polymerization Example 1 | 5 mm | Absent | 88 | 1.1 | 2.4 | Absent |
| | With polyamic acid structure | | | | | | |
| Example 3-2 | Condensation Polymerization Example 1 | 10 mm | Absent | 92 | 1.8 | 4.1 | Absent |
| | With polyamic acid structure | | | | | | |
| Example 1-3 | Condensation Polymerization Example 1 | 15 mm | Absent | 92 | 2.2 | 6.1 | Absent |
| | With polyamic acid structure | | | | | | |
| Example 3-3 | Condensation Polymerization Example 1 | 20 mm | Absent | 92 | 3.9 | 8.3 | Absent |
| | With polyamic acid structure | | | | | | |
| Example 3-4 | Condensation Polymerization Example 1 | 25 mm | Absent | 92 | 6.5 | 14.7 | Absent |
| | With polyamic acid structure | | | | | | |
| Example 3-5 | Condensation Polymerization Example 1 | 30 mm | Absent | 94 | 9.6 | 21.4 | Absent |
| | With polyamic acid structure | | | | | | |

In any example in which the height of the photospacers (cell thickness) was changed in the range of 5 to 30 mm, no cracked pattern was observed. For optical shutters, the haze is preferably 90% or higher. However, the PNLC cell of Example 3-1 in which the cell thickness was 5 mm showed a haze of lower than 90%. The PNLC cell of Example 3-5 in which the cell thickness was 30 mm showed a significant decrease in response characteristics. Thus, the cell thickness in the range of 10 to 25 mm is considered to be appropriate for use as an optical shutter.

What is claimed is:

1. An optical shutter for camera modules, comprising:
a pair of substrates bonded together with a seal; and
a polymer network liquid crystal layer sealed between the substrates,
wherein at least one of the substrates includes a transparent electrode made of an oxide conductive film and a coating film covering the transparent electrode and containing a polymer with a polyamic acid structure in a main chain.

2. The optical shutter for camera modules according to claim 1,
wherein the polymer contains a group represented by the following formula (A) in a side chain, 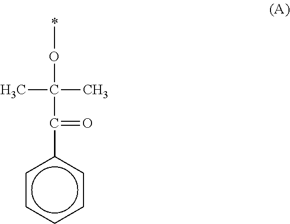
wherein * represents a binding site.

3. The optical shutter for camera modules according to claim 1,
wherein the polymer contains a structure in which a structure derived from a group represented by the following formula (A) and a polymer network in the polymer network liquid crystal layer are bound, 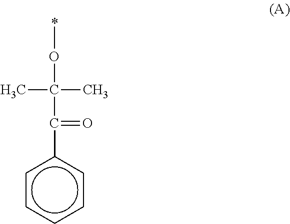
wherein * represents a binding site.

4. The optical shutter for camera modules according to claim 1,
wherein the polymer network liquid crystal layer has a thickness of 10 to 25 μm.

5. The optical shutter for camera modules according to claim 1,
wherein the oxide conductive film contains indium tin oxide, zinc oxide, or tin oxide.

6. The optical shutter for camera modules according to claim 1,
wherein the transparent electrode has a thickness of 5 to 50 nm.

7. The optical shutter for camera modules according to claim 1,
wherein the optical shutter comprises one or more wall members disposed to surround a center of the polymer network liquid crystal layer in a region surrounded by the seal between the substrates.

8. The optical shutter for camera modules according to claim 7,
wherein the wall members are disposed to repeatedly surround the center of the polymer network liquid crystal layer.

9. A method for producing an optical shutter for camera modules, the method comprising:
forming a coating film containing a polymer with a polyamic acid structure in a main chain on a transparent electrode that is made of an oxide conductive film and included in a first substrate;
disposing an uncured sealant in a frame shape on the first substrate or a second substrate;
dropping a liquid crystal material containing a polymer network forming monomer on the first substrate or the second substrate;
overlaying the second substrate on the first substrate via the uncured sealant; and
curing the uncured sealant and polymerizing the polymer network forming monomer in the liquid crystal material.

10. The method for producing an optical shutter for camera modules according to claim 9,
wherein the polymer contains a group represented by the following formula (A) in a side chain, and
during curing of the uncured sealant and polymerization of the polymer network forming monomer, a radical generated from the group represented by the following formula (A) in the polymer is reacted with the polymer network forming monomer, 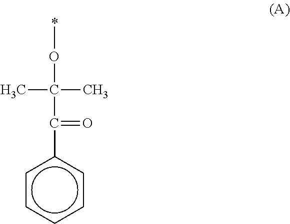
wherein * represents a binding site.

11. The method for producing an optical shutter for camera modules according to claim 9, further comprising
forming one or more wall members on the first substrate,
wherein the uncured sealant is disposed on the first substrate,
the liquid crystal material is dropped on the first substrate, and
the one or more wall members are disposed in a region to be surrounded by the uncured sealant to surround a position on which the liquid crystal material is to be dropped.

12. The method for producing an optical shutter for camera modules according to claim 11,
wherein the wall members are disposed in a region to be surrounded by the uncured sealant to repeatedly surround a position on which the liquid crystal material is to be dropped.
